(19) United States
(12) Patent Application Publication
(10) Pub. No.: US 2020/0051187 A1
(43) Pub. Date: Feb. 13, 2020

(54) RAILING CONFIGURATION SYSTEM

(71) Applicant: Peak Innovations Inc., Richmond (CA)

(72) Inventors: Simon WALKER, Delta (CA); Craig LAWSON, Burnaby (CA); Adam MANTEI, Burnaby (CA); Pedram FAGHANI, Vancouver (CA)

(21) Appl. No.: 16/344,761

(22) PCT Filed: Nov. 30, 2017
(86) PCT No.: PCT/CA2017/051443

§ 371 Date: Apr. 24, 2019

Related U.S. Application Data
(60) Provisional application No. 62/428,125, filed on Nov. 30, 2016.

(51) Int. Cl. G06Q 50/08; G06F 16/25; G06Q 30/00; G06Q 10/06; G06F 17/50; E04F 11/18

(52) U.S. Cl. CPC G06Q 50/08; G06F 16/252; E04F 11/18; G06Q 10/06313; G06F 17/5004; G06Q 30/018

(57) ABSTRACT

A computer-implemented method for facilitating construction of a railing system has a database comprising data regarding one or more types of railing parts and data regarding an organization of the one or more railing parts into one or more kits. The user inputs, through a graphical user interface, a configuration for the railing system. Based on the minimum number for each of the types of railing parts and the data in the database regarding the organization of the one or more railing parts into the one or more kits, a minimum number for each of the kits required for the railing system is determined and displayed.

### FIELD OF THE INVENTION

The invention relates to a system for facilitating the construction of a railing system for a deck.

### BACKGROUND OF THE INVENTION

Railing systems for any number of outdoor applications are well-known. For example, residential decks, pool decks, and playgrounds all utilize any number of conventional railing systems. Conventional railing systems typically comprise elongated railings, posts, pickets, spacers, and other associated hardware.

When designing a railing system for a structure (e.g. a deck), several factors come into consideration. These may include factors such as aesthetics, the dimensions of the structure, building code requirements, etc. As these factors may be different for different projects, the railing system itself may vary from project to project.

Once a particular railing system has been designed, it is useful and important to determine the type and amount of the railing hardware required to build the railing system. In some cases, railing hardware is not individually sold but instead, several pieces of hardware are bundled together in kits. For example, a kit may contain a number of pickets and spacers. In such cases, it would be beneficial to determine the minimum number of kits required to construct the particular railing system in order to avoid unnecessary wastage.

### SUMMARY OF THE INVENTION

According to one aspect of the invention, a computer-implemented method for facilitating construction of a railing system for a defined area comprises the steps of maintaining a database comprising data regarding one or more types of railing parts for the railing system and data regarding an organization of the one or more railing parts into one or more kits; inputting, through a graphical user interface, a configuration for the railing system, the configuration comprising one or more dimensions; determining, based on the dimensions and the data in the database regarding the one or more types of railing parts, a minimum number for each of the types of railing parts required for the railing system; determining, based on the minimum number for each of the types of railing parts and the data in the database regarding the organization of the one or more railing parts into the one or more kits, a minimum number for each of the kits required for the railing system; and displaying, through the graphical user interface, the minimum number for each of the kits.

In another aspect of the invention, the database further comprises data regarding building regulations for different areas.

In still another aspect of the invention, the method further comprises the steps of inputting, through the graphical user interface, an address for the railing system; determining, based on the address and the data regarding building regulations for different areas, an appropriate building regulation for the address; and applying the appropriate building regulation to the railing system by limiting the configuration such that the railing system is in compliance with the appropriate building regulation.

In a further aspect of the invention, the step of applying the appropriate building regulation to the railing system further comprises displaying, through the graphical user interface, a warning indicating when the configuration is limited.

In still a further aspect of the invention, the method further comprises the step of storing the configuration in the database.

In yet still a further aspect of the invention, the method further comprises the step of storing the minimum number for each of the kits in the database.

In another aspect of the invention, the method further comprises the step of storing the location in the database.

In still another aspect of the invention, the method further comprises the step of displaying, through the graphical user interface, a visual representation of the configuration.

In still yet another aspect of the invention, the method further comprises the step of storing the visual representation in the database.

In a further aspect of the invention, the graphical user interface is web-based.

In still a further aspect of the invention, the step of inputting the configuration comprises choosing one or more items from a set of the railing parts.

In still yet a further aspect of the invention, the configuration further comprises information regarding one or more structures proximate to the deck, the structures including one or more of the following: walls or columns.

In another aspect of the invention, the method further comprises the step of limiting, based on the information, the configuration such that the railing system integrates with the structures.

In still another aspect of the invention, the database further comprises data regarding costs for each of the kits.

In still yet another aspect of the invention, the method further comprises the step of determining, based on the data regarding costs for each of the kits, a list of the railing kits required for the railing system such that a total cost for all of the railing kits in the list of the railing kits is minimized.

The foregoing was intended as a summary only and of only some of the aspects of the invention. It was not intended to define the limits or requirements of the invention. Other aspects of the invention will be appreciated by reference to the detailed description of the preferred embodiments. Moreover, this summary should be read as though the claims were incorporated herein for completeness.

### BRIEF DESCRIPTION OF THE DRAWINGS

The preferred embodiment of the invention will be described by reference to the drawings thereof, in which:

FIG. 1 depicts a portion of an exemplary railing system;

FIG. 2 is a block diagram of the preferred embodiment of the invention;

FIG. 3 shows an exemplary kit;

FIG. 4 is an overview of the process flow of the invention;

FIG. 5 depicts the start of the host application for the invention;

FIG. 6 depicts the input of project information for the invention;

FIG. 7 depicts a graphical representation of an exemplary deck after input of the deck information;

FIG. 8 depicts the deck after input of stairs information;

FIG. 9 depicts the deck after input of column information;

FIG. 10 depicts the deck after input of wall information;

FIG. 11 depicts the deck after input of railing information;

FIG. 12 depicts the deck after input of gate information;

FIG. 13 depicts the deck after the locations of the posts have been determined;

FIG. 14 depicts the deck;

FIG. 15 depicts an exemplary kits list for the deck; and

FIG. 16 is a block diagram of another embodiment of the invention.

### DETAILED DESCRIPTION OF THE INVENTION

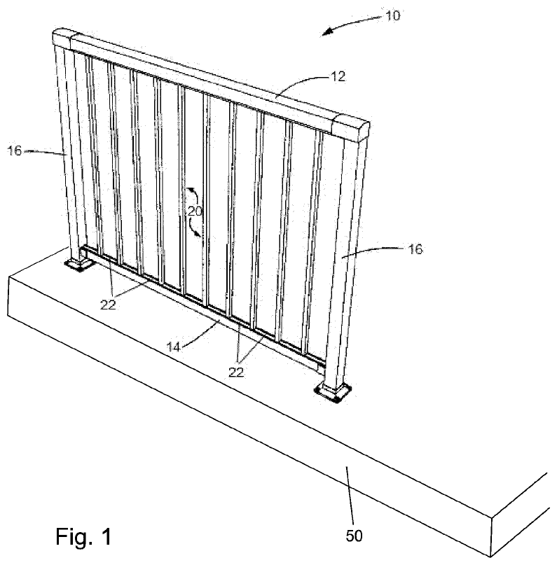

Referring to FIG. 1, a typical railing system 10 for a deck 50 comprises one or more hand rails 12, one or more base rails 14, and one or more posts 16. The posts 16 shown in FIG. 1 are end posts, but the posts 16 may also be mid posts (where the post is in between two rails), corner posts (where the post is in a corner), or stair posts (where the post is attached to stairs). In addition, the railing system 10 may also comprise one or more pickets 20 and spacers 22 (that engage with either the hand rail 12 or the base rail 14 and extend between the pickets 20). FIG. 1 only depicts a portion of a typical railing system 10, and it is understood that other components (e.g. stairs, gates, etc.) may also form part of the railing system 10.

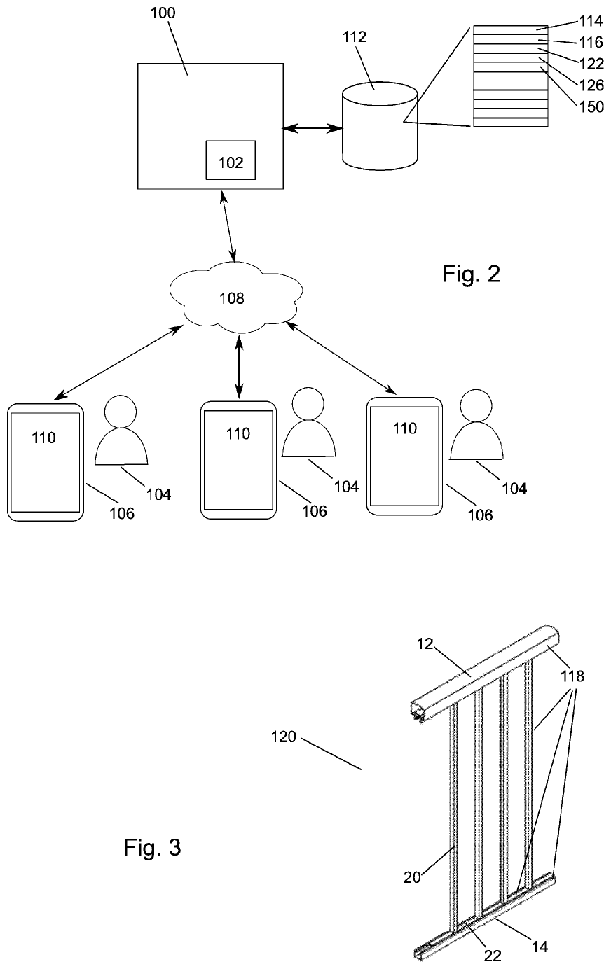

The present invention provides an efficient and convenient way to design the railing system 10 for the deck 50. Referring to FIG. 2, a host server 100 supports a host application 102 that is accessible by remote users 104. The remote users 104 are able to access the host application 102 using communication devices 106 over a communication network 108 (e.g. the Internet). The communication devices 106 may include computers, tablets, smartphones, or other computing devices. Each of the communication devices 106 is configured to display a user interface 110, which is preferably a graphical user interface.

Through the user interface 110, the remote users 104 are able to access the host application 102. For example, where the communication network 108 is the Internet, the host application 102 may be a web-based application that may be accessed using a browser program on the communication device 106 and viewed using the user interface 110.

The host application 102 is associated with a database 112. The database 112 comprises various data, including railing parts data 114 and railing kit data 116. The railing parts data 114 comprises data on one or more types of railing parts 118. The various components of the railing system 10 form the railing parts 118. These components may include items such as pickets 20, hand rails 12, base rails 14, posts 16, spacers 22, gates, brackets, or the like. The railing parts data 114 includes data not only identifying the types of railing parts 118, but also includes data on characteristics of each of the types of railing parts 118. Such characteristics may include colour, dimensions, and any particular usage requirements for the railing part 118.

The railing kit data 116 comprises data regarding the organization of one or more railing parts 118 into one or more kits 120. For example, railing parts 118 are not always sold individually; instead, one or more railing parts 118 may be bundled or assembled together and sold as one kit 120. Different combinations and sets of railing parts 118 may be bundled or assembled together in a variety of ways to form a number of different kits 120. The railing kit data 116 includes data on the composition and organization of each of the kits 120.

Referring to FIG. 3, an example of a kit 120 is shown. In this example, kit 120 comprises various railing parts 118, including four pickets 20, one hand rail 12, one base rail 14 and a number of spacers 22. It is understood that different kits 120 may comprise different amounts and combinations of various railing parts 118.

The database 112 may also comprise project data 122 (regarding projects 124 created by the remote users 104) and profile data 126 (regarding the remote users 104).

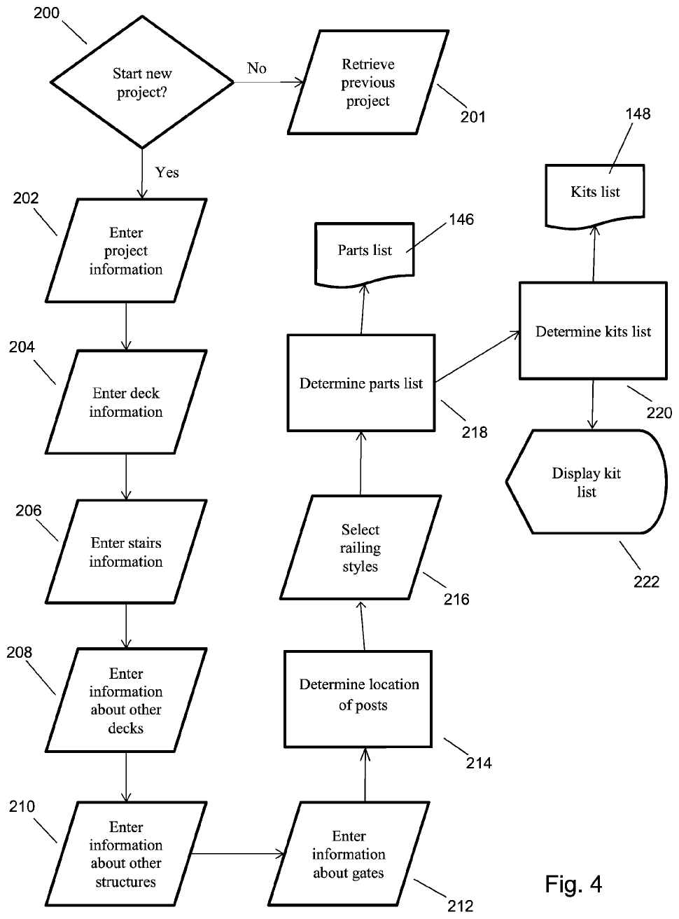

FIG. 4 illustrates the general flow of the process of the invention, which is described in more detail below.

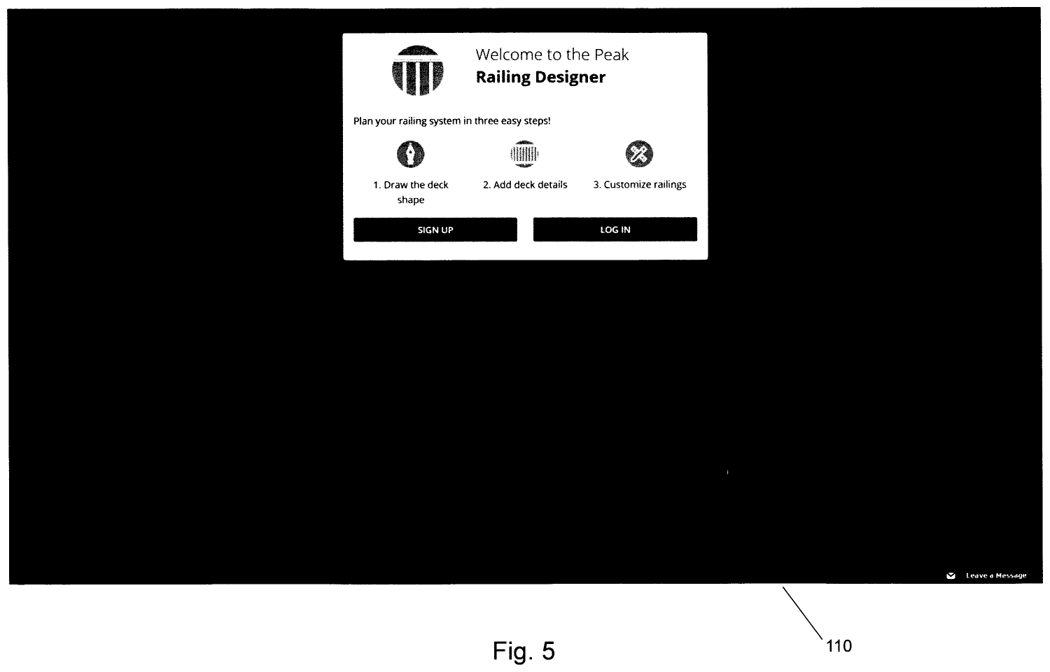

When the remote user 104 first initiates the host application 102, the remote user 104 may be prompted by the user interface 110 to enter a username and/or password in order to log on to the host application 102, as shown in FIG. 5. The host application 102 may then check to see whether the supplied username and password match those in the profile data 126 in the database 112. If they do match, then the host application 102 allows the remote user 104 to proceed. If they do not match, then the host application 102 may allow the remote user 104 to register, thereby creating an entry in the profile data 126 for the remote user 104. Alternatively, if the remote user 104 has forgotten his or her username and/or password, the remote user 104 may be provided with the opportunity to retrieve the username and/or password.

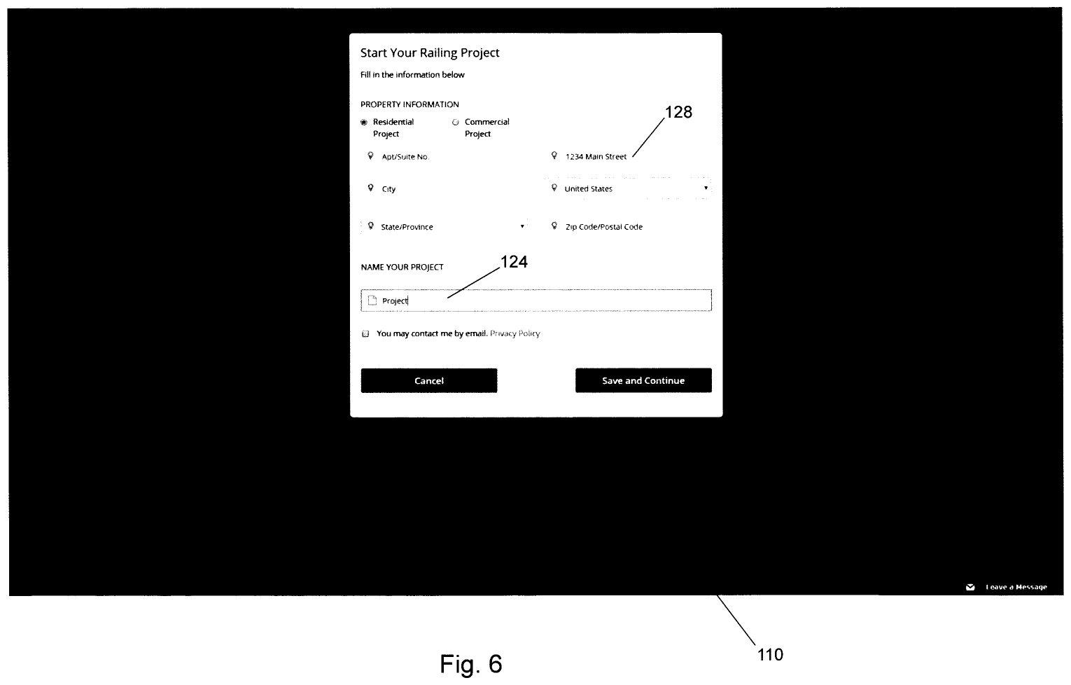

After the remote user 104 has logged on, the remote user 104 may be prompted by the user interface 110 to start a new project 124 or to load a previously saved project 124 (step 200). If the remote user 104 starts a new project 124, the remote user 104 may be prompted (step 202) to enter information regarding the project 124, including an address 150 (or location) for the project 124 and whether the project 124 is for a residential or commercial property, as shown in FIG. 6. The remote user 104 may also be prompted to provide a name for the project 124. If the remote user 104 chooses to retrieve a previous project 124, the host application 102 may retrieve it from the project information 122 of the database 112 (step 201). The remote user 104 can then continue on with the project 124 from where it was last left.

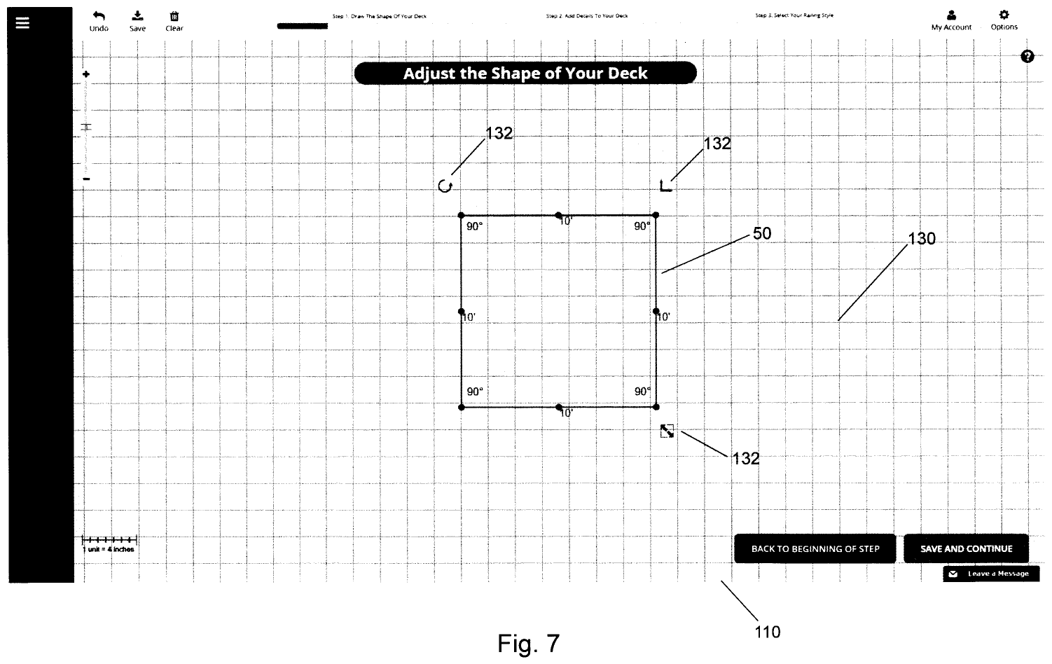

The remote user 104 is then prompted to provide information regarding a defined area, such as the deck 50, for which the railing system 10 will be configured (step 204). Information regarding the deck 50 may include its dimensions and its shape (e.g. square, rectangular, L-shaped, irregularly-shaped, etc.). Preferably, where the user interface 110 is a graphical user interface, the user interface 110 provides the remote user 104 with a grid 130 on which the remote user 104 is able to produce a graphical representation of the deck 50, as shown in FIG. 7. This may be done by using a pointing device (e.g. a mouse) or using a touchscreen. It will be appreciated that in addition to decks, the defined area (or areas) may also be used for patios, balconies, stairs, landings, and the like.

Preferably, the user interface 110 may also depict various icons 132 that assist the remote user 104 in depicting the deck 50. For example, the icons 132 may allow the remote user 104 to rotate or scale the deck 50. In addition, the user interface 110 may allow the remote user 104 to precisely input the dimensions of the deck 50, and the host application 102 can automatically adjust the deck 50 depicted on the user interface 110 based on the inputted dimensions.

Preferably, the user interface 110 will also display the dimensions and relevant angles of the deck 50, as shown in FIG. 7.

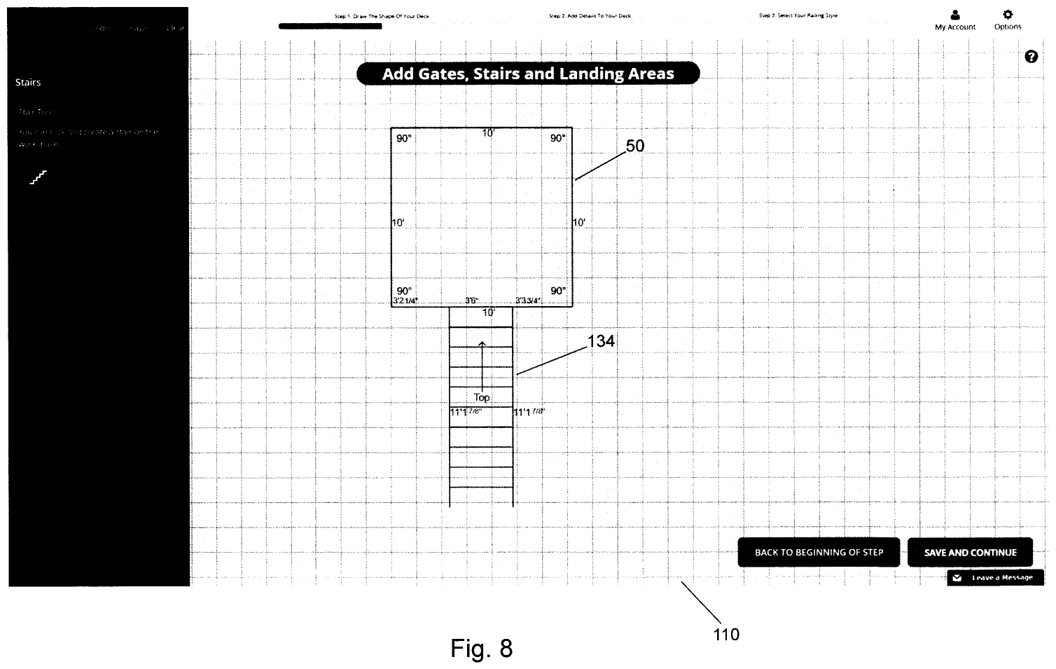

After the dimensions and configuration of the deck 50 have been specified and depicted on the user interface 110, the remote user 104 may be then prompted to indicate whether stairs 134 are to be added to the deck 50. If so, the user interface 110 may prompt the remote user 104 to provide information regarding one or more stairs 134 leading to the deck 50 (step 206). If the deck 50 is to have stairs 134, the remote user 104 is prompted to provide specifications for the stairs 134, which may include information regarding the width, rise, and/or run of the stairs 134. In addition, the remote user 104 may be prompted by the user interface 110 about the number of treads for the stairs 134 and the presence of gates 136 (e.g. top and/or bottom gates). Preferably, where the user interface 110 is a graphical user interface, once the remote user 104 has provided the information regarding the stairs 134, the user interface 110 will provide a graphical representation of the stairs 134, which the remote user 104 can manipulate via the user interface 110 to connect it graphically with the deck 50, as shown in FIG. 8.

After all of the stairs 134 have been specified and depicted on the user interface 110, the remote user 104 may then be prompted by the user interface 110 to provide information regarding additional decks 50, if any (step 208). If there are additional decks 50, the remote user 104 may be prompted to provide their dimensions, shape(s), etc. Preferably, where the user interface 110 is a graphical user interface, the remote user 104 is able to draw a graphical representation of the additional deck(s) 50 on the user interface 110 and manipulate them to connect with any existing deck 50 and/or stairs 134.

Preferably, if the remote user 104 does not connect the additional deck(s) 50 to any existing deck 50 and/or stairs 134, the user interface 110 will display an error message advising the remote user 104 of this.

The remote user 104 may also be prompted by the user interface 110 to specify whether the railing system 10 will be installed on the deck surface or on the deck fascia as this may affect the total length of railing required for the railing system 10.

Next, the user interface 110 may prompt the remote user 104 to provide information regarding existing structural features (step 210), such as columns 138 or walls 140. If such structural features are present, the remote user 104 may be prompted by the user interface 110 to provide their dimensions, locations, and/or shapes. For columns 138, this may preferably be carried out when the remote user 104 selects a side 156 of the deck 50 on the user interface 110 on which the column 138 is located. Once selected, the user interface 110 will then prompt the remote user 104 to provide the dimensions, positions, offsets, and general shape (e.g. round or square) of the column(s) 138.

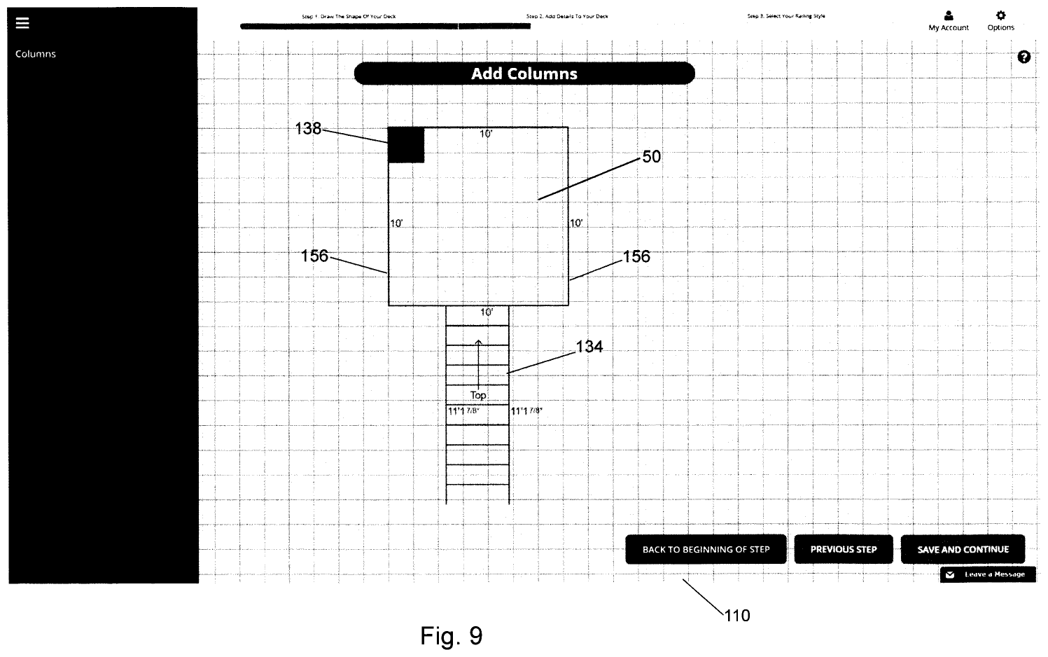

Preferably, where the user interface 110 is a graphical user interface, once the remote user 104 has provided the information regarding the column(s) 138, the user interface 110 will provide a graphical representation of the deck 50 with the column(s) 138, as shown in FIG. 9. In the example shown in FIG. 9, one square column 138 is present at the top left-hand corner of the deck 50.

Similarly, if one or more walls 140 are to be present, the remote user 104 may be prompted by the user interface 110 to provide the orientation and length of the wall(s) 140. Preferably, this may be carried out when the remote user 104 selects a side 156 of the deck 50 on the user interface 110 on which the wall 140 is located. Once selected, the user interface 110 will then prompt the remote user 104 to provide the length and position of the wall 140. The user interface 110 may also prompt the remote user 104 to indicate whether the wall 140 is a full-length wall or a partial wall (i.e. does not extend for the full length of a side of the deck 50).

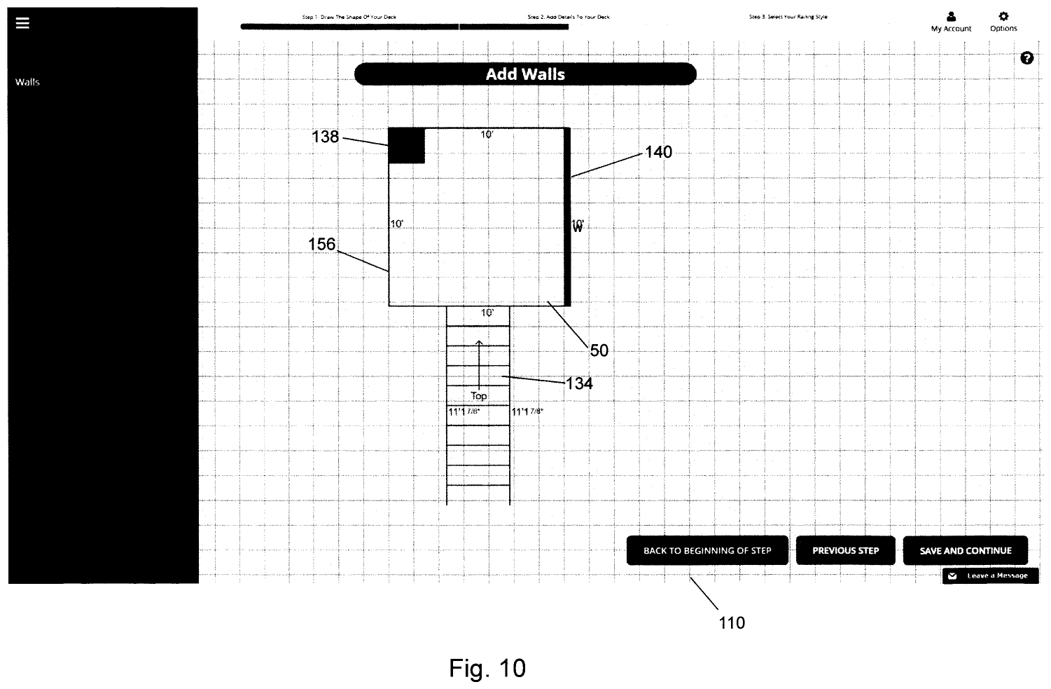

Preferably, where the user interface 110 is a graphical user interface, a graphical representation of the column(s) 138 and wall(s) 140 can be then displayed with the deck(s) 50, as shown in FIG. 10. In the example shown in FIG. 10, one wall 140 is present on the right-hand side of the deck 50.

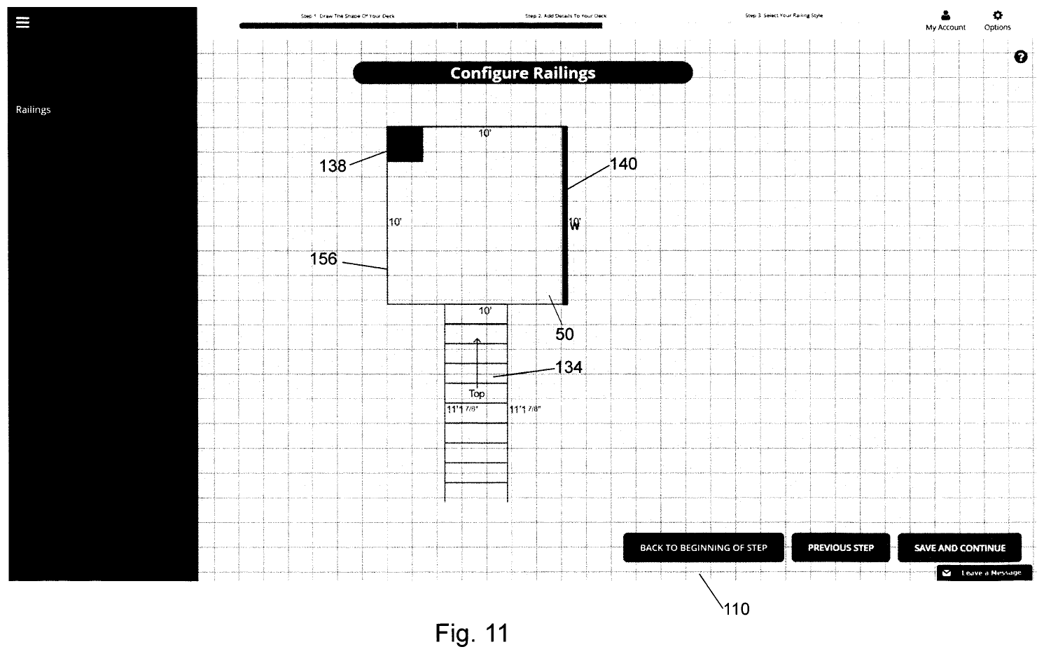

In addition, the remote user 104 may be prompted by the user interface 110 to select one or more sides 156 of the deck(s) 50 for which no railing will be installed. Where the user interface 110 is a graphical user interface, the remote user 104 may select the sides 156 of the deck 50 for which no railing will be installed by selecting the appropriate portions of the deck 50, as shown in FIG. 11.

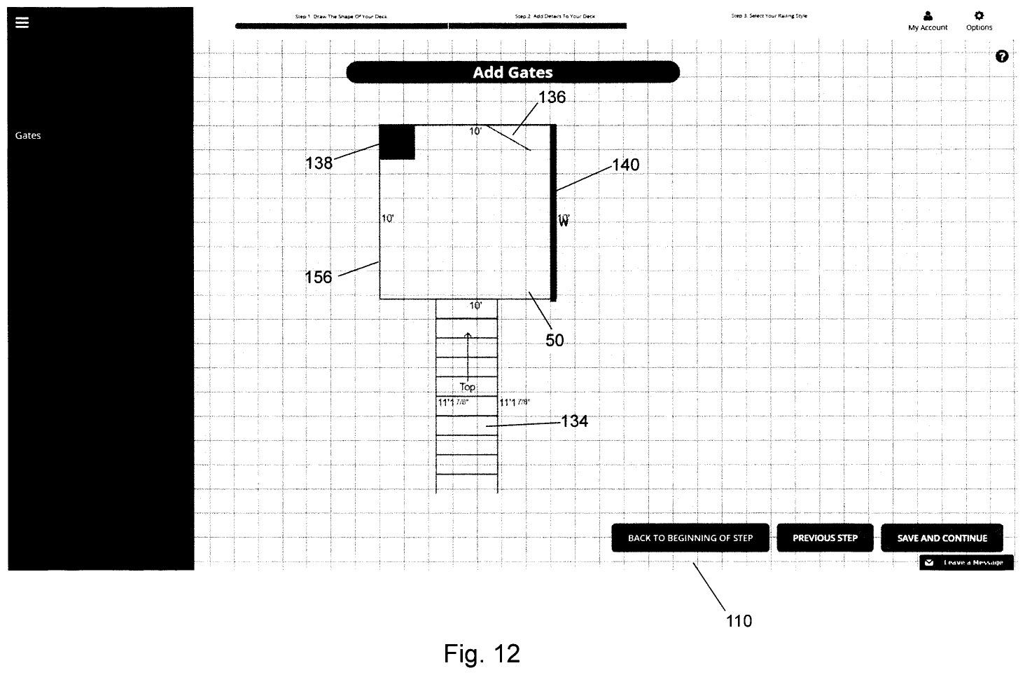

Next, the remote user 104 may also be prompted by the user interface 110 to select one or more locations on the deck 50 for inserting additional gates 136 (step 212). Preferably, this is carried out when the remote user 104 selects a side 156 of the deck 50 on the user interface 110 on which the gate 136 is to be located. The remote user 104 may specify the position, dimensions (e.g. the width), and orientation (e.g. the swing direction) of the gates 136. Where the user interface 110 is a graphical user interface, a graphical representation of the gates 136 can be displayed with the deck 50, as shown in FIG. 12. In the example shown in FIG. 12, one gate 136 is present on the top side of the deck 50.

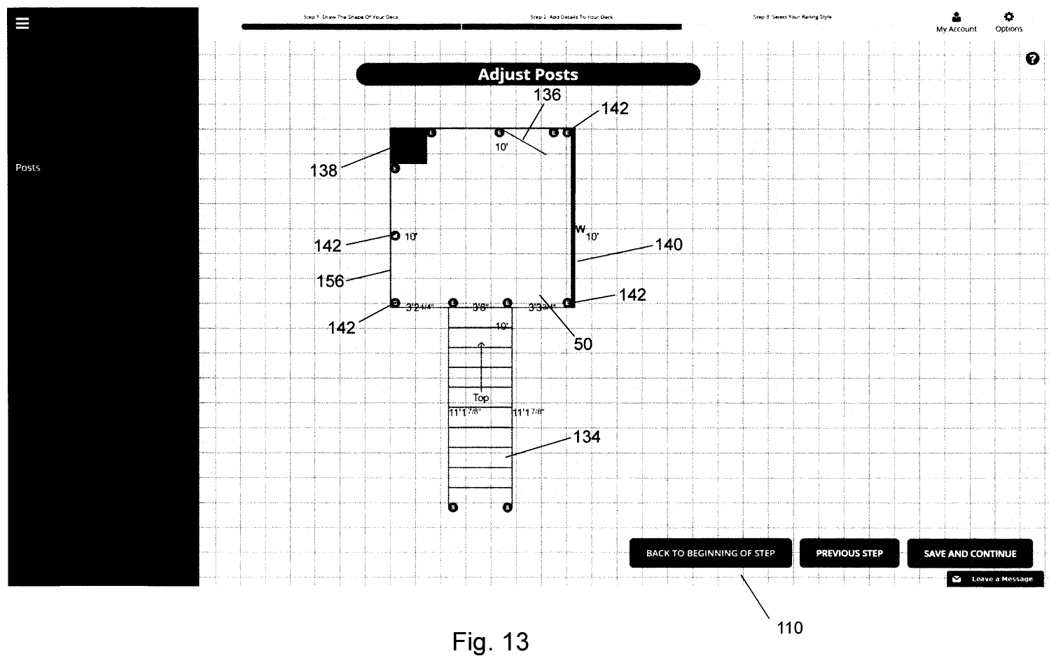

Based on the information provided by the remote user 104 to the user interface 110, the host application 102 determines appropriate locations for posts 142 for the railing system 10 (step 214). This determination takes into account a number of factors, including the distance between respective posts 142, the location of gates 136 (if any), the presence of columns 138 (if any) and walls 140 (if any), the location of stairs 134 (if any), and others. For example, a post 142 should be located proximate to the columns 138 so that the end of the hand rails 12 or base rails 14 can extend from the post 142, resulting in a minimal gap between the post 142 and the column 138. In addition, there may be a maximum allowable distance between adjacent posts 142. Where the user interface 110 is a graphical user interface, a graphical representation of the posts 142 can be displayed, as shown in FIG. 13.

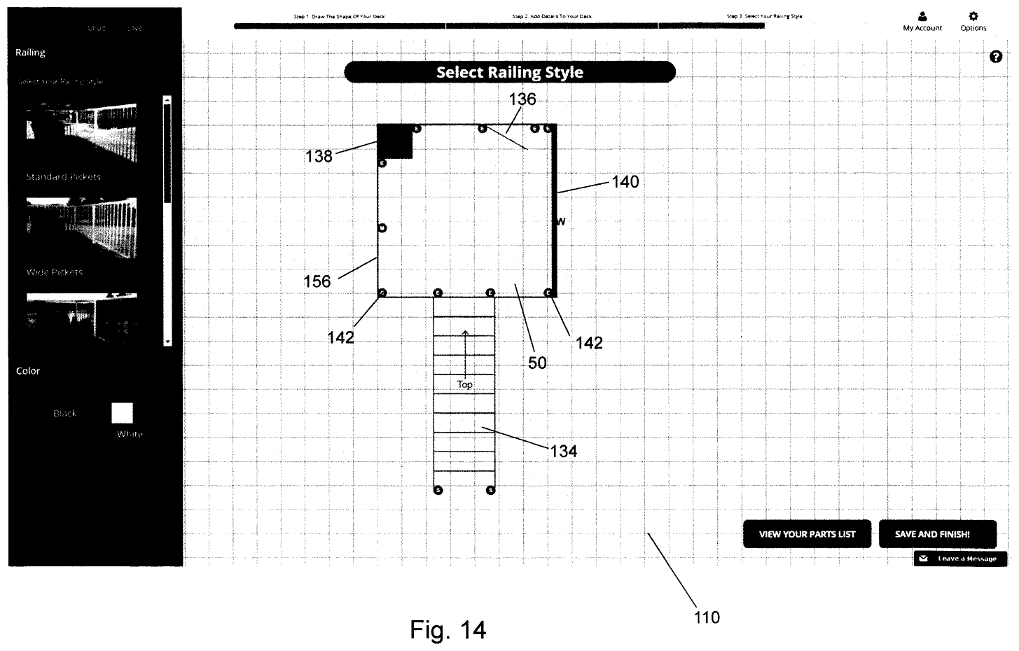

Based on the railing parts data 114, the remote user 104 may also be prompted by the user interface 110 to select certain characteristics for various railing parts 118 (step 216), as shown in FIG. 12. For example, the remote user 104 may be prompted to select a colour for the railing parts 118. The remote user 104 may also be prompted to select a style for pickets 20 or to select using panels (e.g. glass panels, instead of using pickets 20). Where the user interface 110 is a graphical user interface, a graphical representation of the railing system 10 can be displayed, as shown in FIG. 14.

In addition, the host application 102 may restrict certain configurations of the railing system 10 because of physical limitations. For example, if walls 140 are present, the host application 102 may provide the remote user 104 with the option of using one or more brackets for attaching the hand rail 12 and base rail 14 to the walls 140 (instead of the post 16), but only if the brackets can be placed normal to the walls 140. The host application 102 may determine any such limitations based on the configuration of the railing system 10 and the railing parts data 114.

Once the remote user 104 has completed configuration of the railing system 10, the host application 102 determines (step 218) a parts list 146 comprising a list of the railing parts 118 and their respective quantities required to construct the railing system 10. This determination is based on the railing parts data 114 and the configuration of the railing system 10. In order to reduce potential wastage, the determination preferably produces a parts list 146 that comprises a minimum number of each of the railing parts 118 required to construct the railing system 10.

### EXAMPLES

The following examples demonstrate how the minimum number for certain ones of the railings parts 118 may be determined for a particular portion of the deck 50, where L=center-to-center span (in mm); P=minimum number of pickets required; S=minimum number of spacers required; d=end spacer length (in mm); and w=glass panel width (in mm).

### Example 1: Standard Picket and Spacer Optimization (for 16 mm Pickets and 99.7 mm Spacers)

P=1;
Loop:

d=(L−50.8−(P*16+(P−1)*99.7))/2;
If d=<99.7

Goto Out:

Else

P=P+1;

Goto Loop;
Out:

S=(P+1)*2;
Print P;
Print S;

### Example 2: Wide Picket and Spacer Optimization (for 38.1 mm Pickets and 99.7 mm Spacers)

P=1;
Loop:

d=(L−50.8−(P*38.1+(P−1)*99.7))/2;
If d=<99.7

Goto Out:

Else

P=P+1;

Goto Loop;
Out:

S=(P+1)*2;
Print P;
Print S;

### Example 3: Stair Picket and Spacer Optimization

P=1;
Loop:

d=(L−50.8−(P*16+(P−1)*116))/2;
If d=<116

Goto Out:

Else

P=P+1;

Goto Loop;
Out:

S=(P+1)*2;
Print P;
Print S;

### Example 4: Wide Stair Picket and Spacer Optimization

P=1;
Loop:

d=(L−50.8−(P*38.1+(P−1)*116))/2;
If d=<116

Goto Out:

Else

P=P+1;

Goto Loop;
Out:

S=(P+1)*2;
Print P;
Print S;

### Example 4: Glass Picket and Spacer Optimization (for 6 in Glass Panel)

P=1;
Loop:

d=(L−50.8−(P*155+(P−1)*93))/2;
If d=<93

Goto Out:

Else

P=P+1;

Goto Loop;
Out:

S=(P+1)*2;
Print P;
Print S;

### Example 5: Glass Panel and Standard Spacer Optimization

P=0;
//Glass Selection - may already be correctly coded in configurator, included for clarity here

| | |
|---|---|
| If L>=1130.3 AND L<1739.9 | //Rail length more than 42.5″, less than 66.5″ |

w=1067;

| | |
|---|---|
| Else If L>=1739.9 AND L<=1880 | //Rail length more than 66.5″, less than 72″ |

w=1676;

Else

| | |
|---|---|
| ERROR; | //not possible (too big or small), contact customer support if applicable |

Loop:

d=(L−50.8−w−P*(16+99.7))/2;
If d=<99.7

Goto Out:

Else

P=P+2;

Goto Loop;
Out:

S=(P+2)*2;
If P==0

| | |
|---|---|
| S=0; | //case where glass gasket is sufficient, no spacers needed |

Print P;
Print S;

### Example 6: Glass Panel and Wide Spacer Optimization

P=0;
//Glass Selection - may already be correctly coded in configurator, included for clarity here

| | |
|---|---|
| If L>=1130.3 AND L<1739.9 | //Rail length more than 42.5″, less than 66.5″ |

w=1067;

| | |
|---|---|
| Else If L>=1739.9 AND L<=1880 | //Rail length more than 66.5″, less than 72″ |

w=1676;

Else

| | |
|---|---|
| ERROR; | //not possible (too big or small), contact customer support if applicable |

Loop:

d=(L−50.8−w−P*(38.1+99.7))/2;
If d=<99.7

Goto Out:

Else

P=P+2;

Goto Loop;
Out:

S=(P+2)*2;
If P==0

| | |
|---|---|
| S=0; | //case where glass gasket is sufficient, no spacers needed |

Print P;
Print S;

Based on the parts list 146, the host application 102 determines (step 220) a kits list 148 comprising a list of the kits 120 required to construct the railing system 124. This determination is based on the railing kit data 116 and the parts list 146. In order to reduce potential wastage, the determination preferably produces a kits list 148 that comprises a minimum number of each of the kits 120 required to construct the railing system 10.

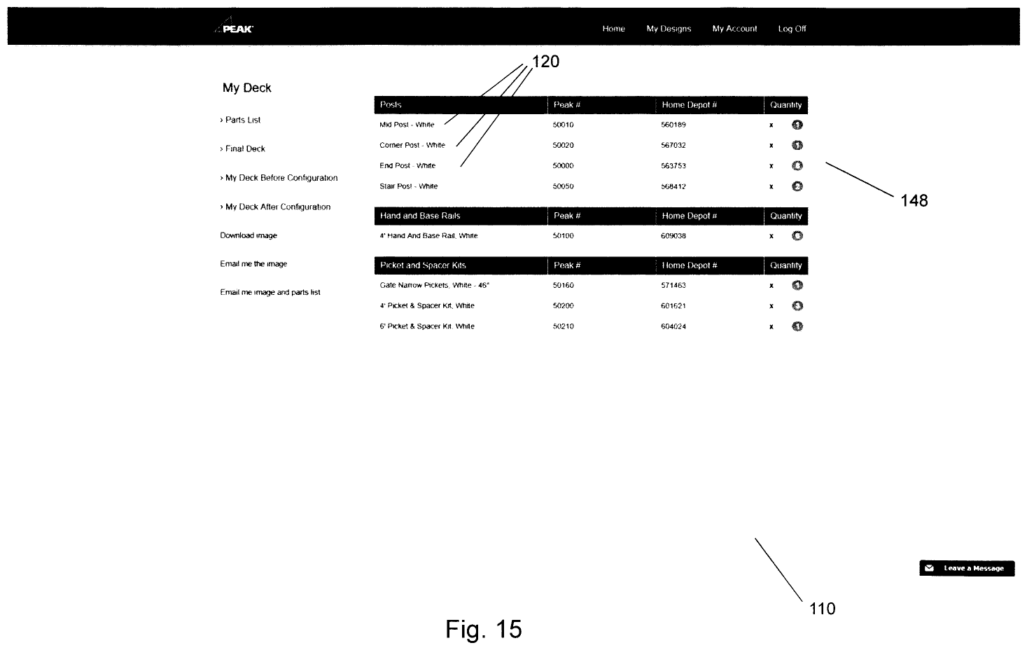

The kits list 148 is preferably displayed (step 222) on the user interface 110, as shown in FIG. 15. If desired, the parts list 146 may also be displayed on the user interface 110.

In another embodiment, the database 112 further comprises building regulations data 150. The building regulations data 150 comprises information on building regulations for different areas. When the remote user 104 enters the address 128 for the project 124, the host application 102 determines the appropriate area for the address 128 and, based on the building regulations data 150, determines the appropriate building regulations for the project 124.

Thereafter, the host application 102 applies the appropriate building regulations to restrict the configuration of the railing system 10. For example, certain areas (e.g. Florida) prohibit the use of glass panels. Therefore, if the remote user 104 indicates that the project 124 is located in Florida, the host application 102 will apply the appropriate building regulations from Florida and prevent the remote user 104 from subsequently selecting glass panels for the project. The user interface 110 may provide a warning to the remote user 104 advising of the restriction.

In addition to the use of glass panels, building regulations may also limit the maximum length for hand rails 12 and base rails 14. This may differ in different areas and may also differ based on whether it is in a residential or commercial setting. Therefore, depending on the address 128 for the project and its setting (i.e. residential or commercial), the host application 102 applies the appropriate building regulation from the building regulations data 148 to restrict the configuration of the railing system 10. This restriction may include restricting the placement of posts 142 so that the hand rails 12 and base rails 14 are appropriately separated by the posts 142 (e.g. such that the hand rails 12 and base rails 14 are not too long).

Preferably, the host application 104 stores the configuration of the railing system 10, the parts list 146, the kits list 148, and the address 128 in the database 112 as a project 124 in the project data 126 for later retrieval. In addition, the host application 104 preferably provides the remote user 104 with the ability to save the project 124 at any time throughout the process, through appropriate input on the user interface 110.

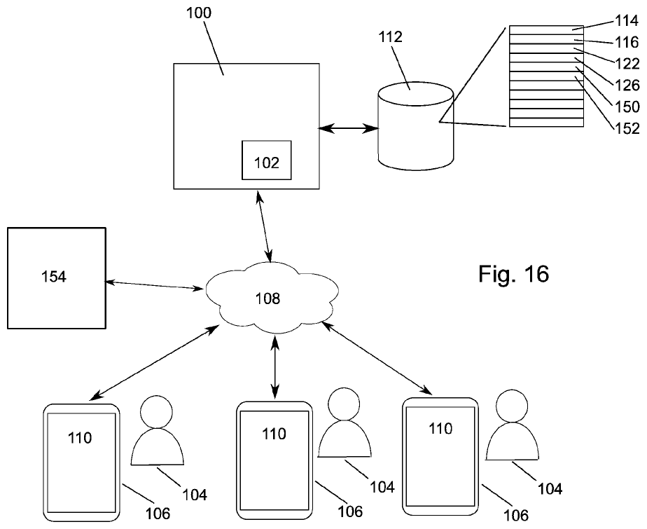

In another embodiment shown in FIG. 16, the host application 102 may also determine the kits list 148 so that the cost to purchase all of the kits 120 in the kits list 148 is minimized. In other words, in addition to optimization based on building regulations and/or physical limitations, the host application 102 can also provide a degree of cost optimization. In order to do so, the database 112 may also comprise cost data 152 relating to the cost to purchase each of the kits 120.

The cost data 152 may be based on estimated costs for each of the kits 120. These estimated costs may already be stored in the database 112. Alternatively, referring to FIG. 16, the host application 102 may also, from time to time, update the cost data 152 in the database 112 by retrieving over the communications network 108 current cost data 152 from third parties 154, such as retailers. In addition to retrieving the current cost data 152 from time to time, the host application 102 may also retrieve real-time cost data 152 from third parties 154 each time a determination of the kits list 148 is made.

For example, the hardware associated with constructing a section of fencing (e.g. pickets 20, hand rails 12, etc.) may be sold in different kits 120 corresponding to different configurations. In a first kit 120a, the included hardware may comprise the hardware required to construct a 4-foot section of fencing, while in a second kit 120b, the included hardware may comprise the hardware required to construct a 6-foot section of fencing. If the railing system 10 required a 10-foot section of fencing, the host application 102 may determine, based on the cost data 152, that it would be more cost efficient to use one of the first kit 120a and one of the second kit 120b, rather than three of the first kits 120a. This could also result in less wastage of material.

The host application 102 is able to determine the kits list 148 based on one or both of the following factors: (1) an absolute minimum of kits 120 required for the railing system 10; and (2) a minimum total cost to purchase the kits 120 required for the railing system 10. In some cases, the two factors may result in identical kits lists 148; however, there may be instances when they will result in different kits lists 148 (e.g. where there are discounts for certain kits 120). For example, in the example described above, if the first kit 120a cost $10 each and the second kit 120b cost $30 each, then it would be more cost efficient to purchase three of the first kits 120a (for a total of $30), rather than purchasing one of the first kit 120a and one of the second kit 120b (for a total of $40).

It will be appreciated by those skilled in the art that the preferred embodiment has been described in some detail but that certain modifications may be practiced without departing from the principles of the invention.

1. A computer-implemented method for facilitating construction of a railing system for a defined area, the method comprising the steps of:
maintaining a database comprising data regarding one or more types of railing parts for the railing system and data regarding an organization of the one or more railing parts into one or more kits;
inputting, through a graphical user interface, a configuration for the railing system, the configuration comprising one or more dimensions;
determining, based on the dimensions and the data in the database regarding the one or more types of railing parts, a minimum number for each of the types of railing parts required for the railing system;
determining, based on the minimum number for each of the types of railing parts and the data in the database regarding the organization of the one or more railing parts into the one or more kits, a minimum number for each of the kits required for the railing system; and
displaying, through the graphical user interface, the minimum number for each of the kits.

2. The method of claim 1, wherein the database further comprises data regarding building regulations for different areas.

3. The method of claim 2, further comprising the steps of:
inputting, through the graphical user interface, an address for the railing system;
determining, based on the address and the data regarding building regulations for different areas, an appropriate building regulation for the address; and
applying the appropriate building regulation to the railing system by limiting the configuration such that the railing system is in compliance with the appropriate building regulation.

4. The method of claim 3, wherein the step of applying the appropriate building regulation to the railing system further comprises displaying, through the graphical user interface, a warning indicating when the configuration is limited.

5. The method of claim 1, further comprising the step of storing the configuration in the database.

6. The method of claim 1, further comprising the step of storing the minimum number for each of the kits in the database.

7. The method of claim 3, further comprising the step of storing the location in the database.

8. The method of claim 1, further comprising the step of displaying, through the graphical user interface, a visual representation of the configuration.

9. The method of claim 1, further comprising the step of storing the visual representation in the database.

10. The method of claim 1, wherein the graphical user interface is web-based.

11. The method of claim 1, wherein the step of inputting the configuration comprises choosing one or more items from a set of the railing parts.

12. The method of claim 1, wherein the configuration further comprises information regarding one or more structures proximate to the deck.

13. The method of claim 12, wherein the structures include one or more of the following: walls or columns.

14. The method of claim 13, further comprising the step of limiting, based on the information, the configuration such that the railing system integrates with the structures.

15. The method of claim 1, wherein the database further comprises data regarding costs for each of the kits.

16. The method of claim 15, further comprising the step of retrieving from third parties, over a network, the data regarding costs each of the kits.

17. The method of claim 16, further comprising the step of determining, based on the data regarding costs for each of the kits, a list of the railing kits required for the railing system such that a total cost for all the railing kits in the list of the railing kits is minimized.
